(19) United States
(12) Patent Application Publication
(10) Pub. No.: US 2020/0393824 A1
(43) Pub. Date: Dec. 17, 2020

(54) Automatic Inspection System

(71) Applicant: Hitachi, Ltd., Tokyo (JP)

(72) Inventors: Kazuo ONO, Tokyo (JP); Takuma NISHIMURA, Tokyo (JP); Yoshinori MOCHIZUKI, Tokyo (JP)

(21) Appl. No.: 16/826,862

(22) Filed: Mar. 23, 2020

(30) Foreign Application Priority Data
Jun. 11, 2019 (JP) 2019-108542

(51) Int. Cl. G05B 23/02; G01M 99/00; G06N 20/00

(52) U.S. Cl. CPC G05B 23/0243; G06N 20/00; G01M 99/00

(57) ABSTRACT

When the learning process is performed and the learning result is set in the wireless slave device, the time required for installing the wireless slave device is increased. Further, when data including the state of the inspection target object detected by the wireless slave device is transmitted as it is, the data size is increased, and the power consumption of the wireless slave device is also increased. A wireless slave device transmits a state of an inspection target object to a setting device as learning data, obtains, as an analysis result, a degree of difference between the state of the inspection target object and the normal state of the inspection target object based on a learning result set by the setting device, and wirelessly transmits data including the analysis result to the wireless master device. The setting device transfers the learning data received from the wireless slave device to the analysis management device and sets the learning result transmitted from the analysis management device in the wireless slave device. The analysis management device extracts a characteristic value characterizing the state of the inspection target object from the learning data transferred from the setting device and transmits the extracted characteristic value to the setting device as a learning result.

### BACKGROUND OF THE INVENTION

### 1. Field of the Invention

The present disclosure relates to an automatic inspection system.

### 2. Description of Related Art

At sites such as power plants, chemical plants, and steel plants, the equipment such as motors, compressors, and turbines are installed. As the equipment is used for a long time, the bearings and insulators deteriorate, and this generates noise. Conventionally, an operation has been performed, in which a worker hears operating sounds of equipment such as a motor, a compressor, and a turbine to determine whether or not the equipment is in normal state. However, in order for the worker to hear and recognize abnormal noise, a long accumulated experience is necessary. Further, since the worker walks around a large site and checks for abnormal noises with his or her own ears, the load on the worker increases. In recent years, skilled workers capable of hearing and distinguishing abnormal noises are aging, while there is the difficulty in ensuring new workers.

Therefore, a technique disclosed in JP-A-2009-273113 (PTL 1) is known as a technique for monitoring a monitoring target object. The monitoring device disclosed in PTL 1 transmits acoustic data and image data processed by an information processing device, and includes a wireless device for receiving a control signal for a microphone and a camera, and an antenna connected to the wireless device.

The related monitoring device described in PTL 1 wirelessly transmits acoustic data of the monitoring target object to a monitor processing device located away from the monitoring target object. Then, the monitor processing device can calculate a frequency spectrum from the acoustic data collected by the monitoring device, and detect the occurrence of an abnormality in the equipment to be monitored, by using a neural network model. While it may vary depending on the frequency of the sound generated by the measurement object, the data size of the acoustic data transmitted from the monitoring device is large. Accordingly, the monitor processing device is burdened with the increased process of measuring and analyzing the acoustic data, and the power consumption of the monitor processing device is likely to increase.

In addition, when a sensor device is installed in a plant on-site as a so-called “post-work”, there are not always the outlets available near the equipment and it is difficult to obtain a wired power supply that can supply power to the sensor device. Accordingly, the sensor device needs a built-in battery as a power source to operate. However, when the sensor device executes processing that consumes a large amount of power (for example, processing of transmitting acoustic data having a large data size), the built-in battery runs out in a short time, and the frequency of battery replacement increases, resulting in poor usability of the sensor device.

Therefore, reducing the size of data to be transmitted by the sensor device has been contemplated. For example, determining whether the equipment is in the normal or abnormal state using a learning result obtained by learning by the sensor device has been contemplated. However, the sensor devices are installed in various environments, and it is not possible to determine uniformly whether the condition of the equipment installed in a certain environment is normal or abnormal. In addition, the learning process for obtaining the learning result takes a considerable amount of time, and the time required for setting the learning result in the sensor device and completing the installation of the sensor device also increases. Further, for example, in cases where many sensor devices are installed in a similar environment in a plant, if the learning process is performed for each sensor device one by one to perform the work of setting the learning result in the sensor device, it takes a very long time to complete the installation of all the sensor devices.

### SUMMARY OF THE INVENTION

The present disclosure has been made in view of such a situation, and an object of the present disclosure is to reduce the time required for installing a wireless slave device and to reduce the power consumption of the wireless slave device after the installation.

An automatic inspection system according to the present disclosure includes a wireless slave device, a setting device capable of communicating with the wireless slave device, and an analysis management device capable of communicating with the setting device. The wireless slave device includes a detection unit that detects a state of an inspection target object, an analysis unit that transmits the detected state of the inspection target object to the setting device as learning data, sets a learning result regarding the state of the inspection target object by the setting device, and obtains, as an analysis result, a degree of difference between the state of the inspection target object detected by the detection unit and the normal state of the inspection target object based on the set learning result, a wireless communication unit that wirelessly transmits data including the analysis result to a wireless master device that collects the analysis result, and a power supply unit that supplies power to the detection unit, the analysis unit, and the wireless communication unit. The setting device includes a learning data transfer unit that transfers the learning data received from the wireless slave device to the analysis management device, and a learning result setting unit that sets the learning result transmitted from the analysis management device in the analysis unit of the wireless slave device. The analysis management device includes a characteristic value extraction unit that extracts a characteristic value characterizing the state of the inspection target object from the learning data transferred from the setting device, and transmits the extracted characteristic value to the setting device as a learning result.

According to the present disclosure, since the learning result learned by an analysis management device is set in a wireless slave device, the wireless slave device is not required to perform the learning process, and the time required for installation of the wireless slave device can be reduced. In addition, after installation, since the wireless slave device wirelessly transmits data including the degree of difference between the state of the inspection target object detected by the detection unit and the normal state of the inspection target object as an analysis result, the data size of the data transmitted by the wireless slave device and the power consumption of the wireless slave device can be reduced.

The problems, configurations, and effects other than those described above will be clarified from the description of the embodiments below.

### BRIEF DESCRIPTION OF THE DRAWINGS

FIG. 1 is a block diagram showing an example of the overall configuration of an automatic inspection system according to a first embodiment of the present disclosure;

FIG. 2 is an explanatory diagram showing an example of a beat sound according to the first embodiment of the present disclosure;

FIG. 3 is a diagram showing an example of a configuration of a packet including an analysis result according to the first embodiment of the present disclosure;

FIG. 4 is a block diagram showing an example of a hardware configuration of a computer that configures a wireless slave device according to the first embodiment of the present disclosure;

FIG. 5 is a block diagram showing an example of a hardware configuration of a computer that configures a wireless relay device, a wireless master device, and a monitoring terminal according to the first embodiment of the present disclosure;

FIG. 6 is a flowchart showing an example of a process executed by a setting device and an analysis management device according to the first embodiment of the present disclosure;

FIG. 7 is a diagram showing contents of background information registered in a registration database according to the first embodiment of the present disclosure;

FIG. 8 is a diagram showing an example of a prediction notification indicated by a prediction notification unit according to the first embodiment of the present disclosure;

FIG. 9 is a flowchart showing an example of a process executed by the wireless slave device according to the first embodiment of the present disclosure;

FIG. 10 is a flowchart showing an example of a process executed by the wireless relay device according to the first embodiment of the present disclosure and an example of a process executed by the wireless master device;

FIG. 11 is a diagram showing an example of a mounting location of the wireless slave device according to the first embodiment of the present disclosure;

FIG. 12 is a diagram showing a first exemplary configuration of a multi-hop network (single manager) of the automatic inspection system according to the first embodiment of the present disclosure;

FIG. 13 is a diagram showing a second exemplary configuration of the multi-hop network (multi-manager) of the automatic inspection system according to the first embodiment of the present disclosure;

FIG. 14 is a diagram showing a third exemplary configuration of the multi-hop network (multi-manager) of the automatic inspection system according to the first embodiment of the present disclosure;

FIG. 15 is a block diagram showing an example of an overall configuration of an automatic inspection system according to a second embodiment of the present disclosure;

FIG. 16 is a block diagram showing an example of a hardware configuration of a computer that configures a wireless slave device used in the automatic inspection system according to a third embodiment of the present disclosure;

FIG. 17 is a diagram showing contents of background information registered in a registration database according to the third embodiment of the present disclosure;

FIG. 18 is a diagram showing an example of a prediction notification indicated by a prediction notification unit according to the third embodiment of the present disclosure; and

FIG. 19 is a block diagram showing an example of a hardware configuration of a computer that configures a wireless slave device used in the automatic inspection system according to a fourth embodiment of the present disclosure.

### DESCRIPTION OF EMBODIMENTS

Hereinafter, embodiments for carrying out the present disclosure will be described with reference to the accompanying drawings. In the description and the drawings, components having substantially the same function or configuration are denoted by the same reference numerals, and duplicate description will not be repeated.

In an automatic inspection system according to each embodiment described below, data representing the state of on-site equipment such as a plant is collected and the collected data is analyzed, to obtain, as an analysis result, a degree of difference between the data collected from normally-operating equipment in a normal state and the currently-collected data, and transmit the result to the wireless master device. The degree of difference is defined by a mathematical distance in a characteristic value space, between a characteristic value represented by the data (normal data) collected at normal times and a characteristic value represented by the data collected this time, for example. When the mathematical distance is less than a predetermined value, the monitoring terminal may determine that the equipment is in a normal state, and when the mathematical distance is greater than or equal to the predetermined value, it may determine that the equipment is in an abnormal state and publish the determination result to the operator.

### First Embodiment

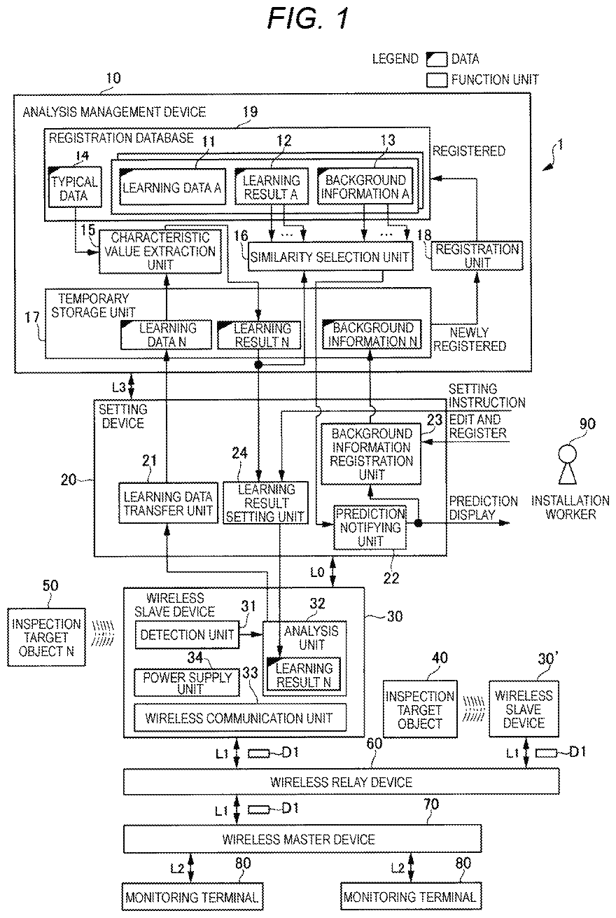

First, an exemplary configuration and an exemplary operation of an automatic inspection system according to the first embodiment of the present disclosure will be described with reference to FIGS. 1 to 14. In the automatic inspection system according to the first embodiment, an abnormality in the equipment can be detected based on a change in the sound generated by the equipment.

FIG. 1 is a block diagram showing an example of the overall configuration of the automatic inspection system 1 according to the first embodiment. The automatic inspection system 1 is applied to, for example, plants such as power plants, chemical plants, steel plants, and substations, or building structures such as buildings.

At least a portion of the equipment provided in the plant that generates sound is a monitoring target (inspection target) for the automatic inspection system 1. In the following description, the equipment as the monitoring target will be referred to as “inspection target object 40” or “inspection target object 50”. In the vicinity of the inspection target objects 40 and 50, there are provided wireless slave devices 30 (an example of a wireless slave device), respectively. The wireless slave devices 30 may be provided in contact with the inspection target objects 40 and 50 or may be provided separately from the inspection target objects 40 and 50. Further, a plurality of wireless slave devices 30 may be provided for each of the inspection target objects 40 and 50. In addition, in another configuration, different wireless slave devices 30 and 30′ may be provided for different inspection target objects 40 and 50, respectively, and the inspection targets 40 and 50 may be monitored by the wireless slave devices 30 and 30′, respectively. Further, in another configuration, the wireless slave devices 30 and 30′ may be provided for one inspection target object 40, and the wireless slave devices 30 and 30′ may monitor different parts of the inspection target object 40, respectively.

In this example, it is assumed that the inspection target object 40 is in a state in which the learning result N has already been set for the wireless slave device 30 by the process according to the present embodiment, and the wireless slave device 30 is currently collecting the sound generated by the inspection target object 40 and analyzing the collected sound. Meanwhile, the inspection target object 50 is hereinbelow a monitoring target on which the wireless slave device 30 is installed. For this reason, in the drawings, the inspection target object 50 newly set as the inspection target is also referred to as the “inspection target object N”. An example in which the automatic inspection system 1 mainly sets the learning result N in the wireless slave device 30 installed on the inspection target object 50 will be described.

The automatic inspection system 1 mainly includes an analysis management device 10, a setting device 20, the wireless slave device 30, a wireless relay device 60, a wireless master device 70, and a monitoring terminal 80. The analysis management device 10 is a cloud-type processing server, for example, and the setting device 20 is a small-size portable terminal such as a tablet terminal or a smartphone that can be carried around by the installation worker 90, for example. The analysis management device 10 may communicate with the setting device 20. The setting device 20 may communicate with the analysis management device 10 and the wireless slave device 30.

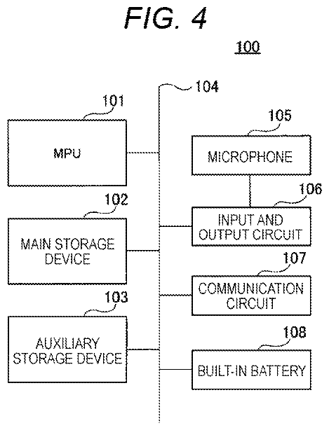

In the automatic inspection system 1 according to the present embodiment, learning data 11, learning result 12, and background information 13 are treated. The learning data 11, the learning result 12, and the background information 13 are all data registered in the registration database 19 of the analysis management device 10. Further, in the present embodiment, the learning data 11 is data on an operating sound of the inspection target object 50 which is detected and recorded by the detection unit 31 (a microphone 105 shown in FIG. 4 to be described below) of the wireless slave device 30. Further, in FIG. 1, “A” is added to the end of information already registered in the analysis management device 10 and “N” is added to the end of information newly registered in the analysis management device 10.

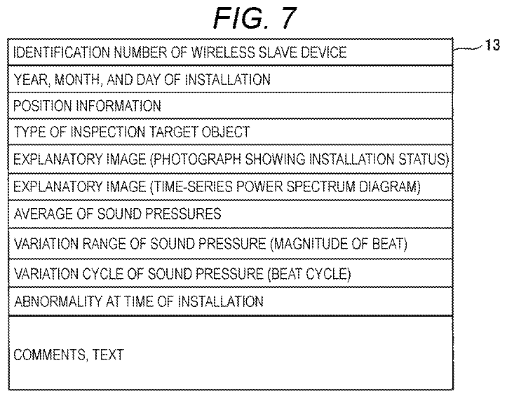

When an installation worker 90 installs the wireless slave device 30 on the inspection target object 50, the installation worker 90 operates the setting device 20 such that the learning data N obtained by recording the operating sound of the inspection target 50 by the wireless slave device 30 is transferred to the analysis management device 10. The analysis management device 10 transmits, to the setting device 20, the background information A and the learning result A of the inspection target object 50 that has the similar learning data N of the operating sound. The setting device 20 notifies the installation worker 90 of the background information A received from the analysis management device 10. The background information A is information indicating the status of the wireless slave device 30 as shown in detail in FIG. 7 to be described below, and since the content thereof is confirmed by the installation worker 90, it may not be necessarily transmitted to the wireless slave device 30.

The installation worker 90 corrects a part of the background information A notified to the setting device 20 that is different from the actual installation information and instructs to register the edited background information A in the analysis management device 10 as the background information N. Since the setting device 20 has a function of displaying and editing the already registered background information A, the installation worker 90 may efficiently register the background information N reflecting the state at the time of installation of the wireless slave device 30 in the analysis management device 10. Then, the analysis management device 10 expands the learning data group for each inspection target object 50 using the background information N instructed to be registered, thereby enhancing the accuracy of the characteristic value.

Various data may be transmitted and received between the wireless slave devices 30 and 30′ and the wireless relay device 60 through a wireless communication path L1. Various data may be transmitted and received between the wireless relay device 60 and the wireless master device 70 through the wireless communication path L1. In addition, various data may be transmitted and received between the wireless master device 70 and the monitoring terminal 80 through a wireless communication path L2. Note that various data may be transmitted and received between the wireless master device 70 and the monitoring terminal 80 through a wired communication path.

The plant is provided with the equipment that generates sounds, such as a motor, a pump, a compressor, a turbine, a boiler, and so on. The frequency of the sound generated in the equipment (several Hz to 1 Hz or less) is much lower than the frequency of several tens of Hz to several tens of kHz that indicates the quality of the sound. Then, the magnitude of the sound generated in the equipment may vary. Such a sound component is referred to as a “beat sound”.

Here, the beat sound will be described.

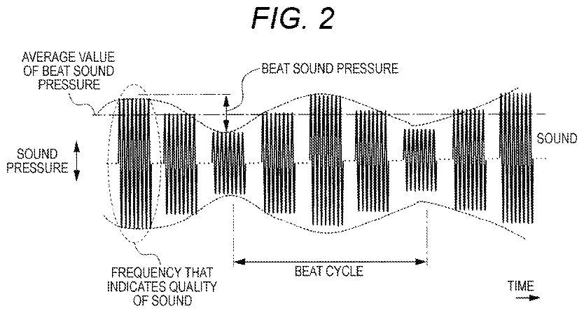

FIG. 2 is an explanatory diagram showing an example of the beat sound.

The beat sound is a sound component that periodically varies in sound pressure (magnitude of sound energy). The beat sound is represented by a beat sound pressure indicating the width of the variation and a cycle of the variation (beat cycle). FIG. 2 shows an example of a high frequency of several tens of Hz to several tens of kHz representing the sound quality described above, and an example of a low frequency (beat cycle) of several Hz to 1 Hz or less representing a sound generated in the equipment. FIG. 2 shows the average value of the beat sound pressure. The average value of the beat sound pressure is a value obtained by averaging the varying beat sound pressures per unit time.

The long-period sound of beat sounds (operating sound) generated in the on-site equipment such as the plant is collected, and the collected sound is analyzed, and the “beat sound pressure” represented by the time series value, the average value, the variation width of the sound pressure, and the cycle of the beat sound pressure (hereinafter referred to as “beat cycle”) may be transmitted to the setting device 20. The setting device 20 may register the background information N in the analysis management device 10, in which the background information N includes the average value of the beat sound pressure, the variation width of the beat sound pressure (magnitude of the beat), and the variation cycle of the beat sound pressure (cycle of beat) received from the analysis unit 32 (see FIG. 7 described below).

Here, the process of the analysis unit 32 calculating the beat sound pressure and the beat cycle will be described.

First, the analysis unit 32 performs sampling and quantization on the amplitude of the analog signal at a high-speed cycle to convert an analog signal into a digital value. Next, the analysis unit 32 samples the sound pressure by time-integration in a low-speed cycle that is twice or greater than that of the frequency at which the sound pressure varies (frequency of the beat sound), and starts time integration of adding the absolute value of the digital value at the low-speed cycle. The result of adding the digital values is obtained by time-integrating the magnitude of the sound, thereby obtaining a sound pressure value corresponding to the energy of the sound. This sound pressure value is treated as a beat sound pressure value. Next, the analysis unit 32 calculates the average value of the beat sound pressure, the width of the variation in the beat sound pressure, and the cycle of the variation in the beat sound pressure, based on the variation in the sound pressure represented by the value obtained by time-integrating the digital value. The beat cycle and the beat sound pressure are calculated from the frequency having the peak and the intensity thereof by performing, by the analysis unit 32, frequency analysis of the time-series data in which the value of the sound pressure varies at a low-speed cycle by the Fourier transform and the like. In addition, the average value of the beat sound pressure is calculated as an average magnitude.

Reference is made back to the description of FIG. 1.

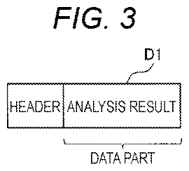

The wireless slave device 30 is used as a “sound sensor device” that collects sound generated from the inspection target object 50. Then, the wireless slave device 30 obtains, as the analysis result, the degree of difference between the data obtained by collecting the sound generated from the inspection target object 50 and the data obtained by collecting the sound generated from the inspection target object 50 in the normal state, and transmits the data including the analysis result to wireless master device 70. The data including the analysis result is a packet D1 of which detailed configuration is shown in FIG. 3 described below, and in the following description, the data including the analysis result is referred to as the packet D1.

The wireless slave device 30 includes a detection unit 31, an analysis unit 32, a wireless communication unit 33, and a power supply unit 34, for example. Each unit included in the wireless slave device 30 is incorporated in a housing having a waterproof and dustproof function. In this example, the wireless slave device 30 will be described as a device in which a sensor function and a wireless communication function are integrated. However, a device, in which a sensor function unit (the detection unit 31 and the analysis unit 32) and a wireless communication function unit (the wireless communication unit 33) are separately configured and connected through a signal line, may also be regarded as the wireless slave device 30.

The detection unit 31 detects the state of the inspection target object 50. The detection unit 31 according to the first embodiment is capable of obtaining a sound generated by the inspection target object 50 and outputting sound data. Then, the detection unit 31 collects the sound emitted from the inspection target object 50 and outputs the collected sound to the analysis unit 32 as an analog electric signal (analog signal). The analog electric signal output from the detection unit 31 is input to the analysis unit 32.

The analysis unit 32 transmits the detected state of the inspection target object 50 to the setting device 20 as learning data N. Therefore, the analysis unit 32 samples the analog electric signal output from the detection unit 31 and converts the sampled signal into learning data N which is digital sound information. Then, the analysis unit 32 transmits the sound indicating the state of the inspection target object 50 to the analysis management device 10 as the learning data N.

In the analysis unit 32, the learning result N related to the state of the inspection target object 50 is set by the setting device 20. Then, based on the set learning result N, the analysis unit 32 may obtain, as an analysis result, the degree of difference between the state of the inspection target object 50 detected by the detection unit 31 and the normal state of the inspection target object 50. For example, based on the learning result N set by the setting device 20, the analysis unit 32 may obtain, as an analysis result, the degree of difference between the sound obtained by the detection unit 31 and the sound generated by the inspection target object 50 in a normal state.

The wireless communication unit 33 wirelessly transmits data including the analysis result to the wireless master device 70 that collects the analysis result. Accordingly, the wireless communication unit 33 wirelessly transmits the packet D1 having the analysis result obtained by the analysis unit 32 attached with the destination information of the wireless master device 70 to the wireless master device 70 through the wireless relay device 60 at a predetermined timing. This process is performed by the wireless communication unit 33 wirelessly communicating with the wireless relay device 60. The packet D1 including the analysis result is transmitted to the wireless relay device 60 as shown in the wireless communication path L1, and further transmitted from the wireless relay device 60 to the wireless master device 70 as shown in the wireless communication path L1.

The power supply unit 34 supplies the power stored in a built-in battery 108 (see FIG. 4 described below) incorporated in the wireless slave device 30 to operate the detection unit 31, the analysis unit 32, and the wireless communication unit 33. The type of the built-in battery 108 is not limited.

Here, an example of an operation performed when the wireless slave device 30 is installed in the vicinity of the inspection target object 50 will be described.

When the installation worker 90 installs the wireless slave device 30, the setting device 20 is connected to the wireless slave device 30 through a transmission interface L0 such as a Universal Serial Bus (USB) or a wireless LAN. The setting device 20 also plays a role of a human interface for the installation worker 90 to register the background information N in the analysis management device 10.

The setting device 20 includes a learning data transfer unit 21, a prediction notification unit 22, a background information registration unit 23, and a learning result setting unit 24.

The learning data transfer unit 21 transfers the learning data N received from the wireless slave device 30 to the analysis management device 10.

The prediction notification unit 22 notifies the background information A related to another inspection target 40 that is predicted by the analysis management device 10 to have a similar state as the inspection target 50. For example, a similarity selection unit 16 of the analysis management device 10 selects, from the registration database 19, the background information A of the operating sound that is similar to the operating sound of the inspection target object 50 currently acquired by the detection unit 31. Then, the prediction notification unit 22 receives the background information A of the operating sound from the analysis management device 10 and notifies the installation worker 90 of the background information A. There may be a plurality of pieces of background information A notified to the installation worker 90. When the plurality of pieces of background information A are notified, the installation worker 90 does not know which background information A may be registered in the analysis management device 10 in association with the learning result N.

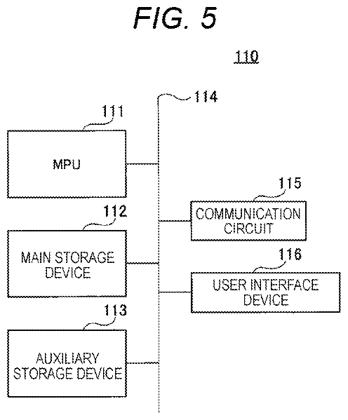

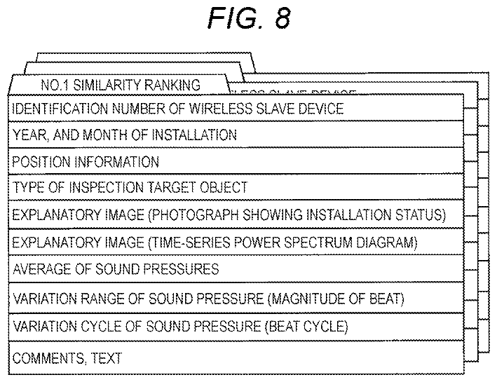

Therefore, the prediction notification unit 22 may notify the registered characteristic values in an order of higher similarity to the characteristic value extracted from the learning data N by a characteristic value extraction unit 15 of the analysis management device 10 (see FIG. 8 described below). The notified registered characteristic value is the information that includes at least the background information A registered in the registration database 19. The process of notifying the registered characteristic value extracted by the analysis management device 10 by the prediction notification unit 22 is performed by displaying the registered characteristic value on a user interface device 116 shown in FIG. 5 described below.

The installation worker 90 confirms the registered characteristic value notified by the prediction notification unit 22. Then, by editing only necessary parts in accordance with the actual installation status of the wireless slave device 30, the installation worker 90 causes the background information A to be the background information N. Then, the installation worker 90 may instruct the analysis management device 10 to register the learning data N, the learning result N, and the background information N in the registration database 19. The installation worker 90 edits the background information A and instructs to register the background information N in the analysis management device 10 through a user interface device 116 shown in FIG. 5 described below.

When the notified background information A is edited, the background information registration unit 23 registers the edited background information A as the background information N in the analysis management device 10. Therefore, the background information registration unit 23 receives the edited background information N and transfers the background information N to the analysis management device 10.

The learning result setting unit 24 sets the learning result N transmitted from the analysis management device 10 in the analysis unit 32 of the wireless slave device 30. Accordingly, the learning result setting unit 24 may receive the learning result N from the analysis management device 10 and set the learning result N in the wireless slave device 30 in accordance with an instruction from the installation worker 90.

The analysis management device 10 is connected to the setting device 20 through a network L3 such as a public network. The analysis management device 10 includes the characteristic value extraction unit 15, the similarity selection unit 16, a temporary storage unit 17, a registration unit 18, and the registration database 19.

The characteristic value extraction unit 15 extracts a characteristic value characterizing the state of the inspection target object 50 from the learning data N transferred from the setting device 20 and transmits the extracted characteristic value to the setting device 20 as a learning result N. Here, when the analysis management device 10 receives the learning data N from the setting device 20, the characteristic value extraction unit 15 displays a typical characteristic of the inspection target object 50 and matches typical data 14 registered in the registration database 19 with the learning data N, and outputs a new characteristic value extracted from the learning data N as a learning result N. The typical data 14 is data obtained in advance from the specifications of the inspection target object 50, for example.

When there is no new characteristic value as a result of matching the typical data 14 with the learning data N, the characteristic value extraction unit 15 outputs the characteristic value included in the typical data 14 as a new learning result N. Then, the learning result N output from the characteristic value extraction unit 15 is transferred to the similarity selection unit 16 and the learning result setting unit 24 of the setting device 20. In the first embodiment, for example, a frequency of a sound, a magnitude of a sound, a temporal change of a sound, and the like are defined as the characteristic values.

The similarity selection unit 16 transmits background information A to the setting device 20, in which the background information A is similar to the characteristic value extracted by the characteristic value extraction unit 15, is associated with the registered characteristic value registered in the analysis management device 10, that is, in the registration database 19, and indicates the status of the wireless slave device 30 installed on the inspection target object 50. Then, the similarity selection unit 16 selects a learning result A similar to the newly received learning result N, from a plurality of learning results 12 previously registered in the registration database 19. The learning result A is the data that is registered in the registration database 19 by the learning process performed for another inspection target object 40 before the current learning process is performed for the inspection target object 50. The learning result A is treated as a set of management information in association with the learning data A and the background information A, as described below. Then, the similarity selection unit 16 transfers the background information A associated with the learning result A to the prediction notification unit 22 of the setting device 20.

The temporary storage unit 17 temporarily stores various data and information mutually communicated between the analysis management device 10 and the setting device 20. The data and information temporarily stored in the temporary storage unit 17 include learning data N, learning result N, and background information N, for example.

The registration unit 18 collectively registers, in the registration database 19, the learning data N, the learning result N, and the background information N temporarily stored in the temporary storage unit 17 as a set of management information. This registration process is performed after the learning result N is set in the wireless slave device 30.

As described above, when the wireless slave device 30 is installed, the learning data N, the learning result N, and the background information N are managed by the setting device 20 and the analysis management device 10 in association with each other. Then, the learning result setting unit 24 of the setting device 20 sets the learning result N in the analysis unit 32 of the wireless slave device 30. The wireless slave device 30 with the learning result N set therein transmits, as an analysis result, a degree of difference from the normal sound to the wireless master device 70, through the wireless relay device 60, thereby starting sound detection.

Then, the registration unit 18 registers the learning data N, the learning result N, and the background information N that are transferred from the setting device 20 as data to be newly registered, as the learning data 11, the learning result 12, and the background information 13 in the registration database 19.

The registration database 19 stores, as a set of management information, the learning data N, the learning result N set in the wireless slave device 30, and the background information N of the wireless slave device 30, which are transferred from the setting device 20 and registered in association with each other. After being registered in the registration database 19, the learning data 11, the learning result 12, and the background information 13 registered in the registration database 19 are treated as the learning data A, the learning result A, and the background information A, respectively.

The wireless relay device 60 forms apart of a sensor network spanning a plant, and may transfer the packet D1 transmitted from the wireless slave device 30 to the wireless master device 70 as described above. Therefore, the wireless relay device 60 may also be referred to as a relay device that relays the packet D1 of the wireless slave device 30 to the wireless master device 70. The part of the sensor network may include a sound sensor network capable of detecting abnormal noise generated from the inspection target objects 40 and 50 and diagnosing the state of the inspection target objects 40 and 50. In this case, in addition to the sound sensor network, the sensor network may include a sensor network capable of detecting at least one or more of information such as temperature, humidity, pressure, voltage value, current value, frequency, resistance value, flow rate, flow velocity, color, and image. Alternatively, all of the sensor networks provided in the plant may be formed by sound sensor networks.

The wireless relay device 60 may receive the packet D1 wirelessly transmitted from one wireless slave device 30 or a plurality of wireless slave devices 30 and 30′, and then wirelessly transmit the packet D1 to the wireless master device 70. Further, the wireless relay device 60 may transfer each packet D1 received from the plurality of wireless slave devices 30 and 30′ to the wireless master device 70. Specifically, the wireless relay device 60 may wirelessly communicate with the plurality of wireless slave devices 30 and 30′, and may transmit the packet D1 received from each of the wireless slave devices 30 and 30′ to the wireless master device 70. Here, the wireless master device 70 instructs about the transmission order of the packet D1 of the plurality of wireless slave devices 30 and 30′, so that the wireless relay device 60 wirelessly receives data received from the wireless slave devices 30 and 30′ via the wireless relay device 60 in accordance with the transmission order.

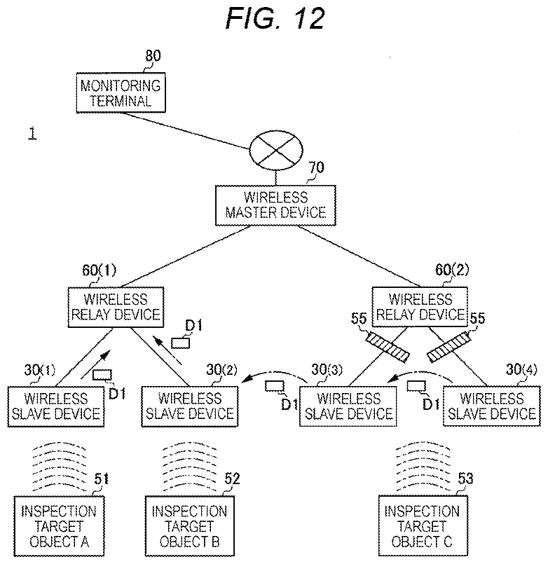

For example, the wireless master device 70 instructs, through the wireless relay device 60, a plurality of wireless slave devices 30 and 30′ sequentially selected by the polling method, to transmit the packet D1. The wireless slave devices 30 and 30′ receiving the instruction from the wireless master device 70 sequentially transmit the packet D1 to the wireless relay device 60. Thereafter, the wireless relay device 60 sequentially transmits the packets D1 received from the respective wireless slave devices 30 and 30′ to the wireless master device 70 in the instructed transmission order. Therefore, the wireless master device 70 may receive the packet D1 while avoiding collision of the packet D1 transmitted from the plurality of wireless slave devices 30 and 30′ through the wireless relay device 60. As shown in FIGS. 12 to 14 which will be described below, the wireless slave devices 30 and 30′ may transfer the packet D1 to the wireless master device 70 by a so-called “bucket relay method” (multi-hop routing) between a plurality of wireless slave devices 30 and 30′ adjacent to each other. At this time, the wireless slave device 30(3) that bucket-relays the packet D1 (see FIGS. 12 to 14) serves as a wireless relay device that relays the packet D1.

Although FIG. 1 shows an example in which only one wireless relay device 60 is provided, a plurality of wireless relay devices 60 may be provided. Further, the wireless communication path L1 may not include the wireless relay device 60. In this case, the wireless slave device 30 may also perform direct wireless communication with the wireless master device 70.

The wireless master device 70 manages data (packet D1) including the analysis result received from the wireless slave device 30 through the wireless relay device 60. Accordingly, the wireless master device 70 has a function of interpreting the contents of the packet D1 (this is referred to as a data parse function, for example) and storing it as a file, for example. The contents of the data described in this file may be a result obtained by converting the analysis result transmitted from the wireless slave device 30 into text, and may be a result obtained by textualizing the packet bit or byte information as it is. Various file formats may be considered, such as tab-separated, space-separated, and comma-separated, and the operator may arbitrarily design the file. The wireless master device 70 transmits an analysis result extracted from the data to the monitoring terminal 80 based on a request from the monitoring terminal 80 that monitors the state of the inspection target objects 40 and 50. Accordingly, the wireless master device 70 holds the analysis result received from the wireless slave devices 30 and 30′. Then, the wireless master device 70 performs a process of publishing a determination result to the monitoring terminal 80, indicating an abnormal or a normal state of the inspection target object 40 and 50 determined from the analysis result.

The wireless master device 70 extracts data including the analysis result from the packet D1 received from the wireless slave device 30 and stores the data in association with the time at which the wireless master device 70 collected the packet D1, so that the data is converted into time-series data. When a storage capacity capable of holding all the time-series data is not provided, the wireless master device 70 may be configured to transfer the data for storage to an external information processing device or information storage device so that the system as a whole can hold all the information. Then, the wireless master device 70 provides the held time-series data to monitoring terminal 80 in response to a request from monitoring terminal 80.

The monitoring terminal 80 is used by an operator (not shown) to monitor the state of the inspection target objects 40 and 50 through the wireless master device 70. The monitoring terminal 80 performs a process of determining the state of the inspection target objects 40 and 50 from the analysis result received from the wireless master device 70 and publishing the determined state. For example, the monitoring terminal 80 outputs, as a monitoring result, a graph representation of time-series data and the like to a display, a printer, and the like, for example. The monitoring terminal 80 may also perform a data analysis process such as a clustering process of the time-series data held by the wireless master device 70 and display a result of analyzing a variation pattern of the degree of abnormality.

The variation pattern of the degree of abnormality is represented by a change in the analysis result of the degree of difference indicated by the time-series data, for example. When the state of the inspection target object 50 is analyzed to be abnormal for a short time, but then immediately analyzed to be normal, since the state of the inspection target object 50 has only temporarily changed, it is often the case that the inspection target object 50 is in a normal state. However, when the state of the inspection target object 50 is continuously analyzed to be abnormal for a long time, it is considered that there is a high possibility that the inspection target object 50 has an abnormality. Thus, the monitoring terminal 80 may notify the presence or absence of abnormality of the inspection target object 50 based on such a variation pattern of the degree of abnormality.

FIG. 3 shows an example of a configuration of the packet D1 including the analysis result.

The packet D1 includes a header and a data part. The data part stores the analysis result.

The header includes a network address (for example, an IP address) specifying the wireless master device 70 as a final destination of the packet D1, or destination information represented by identification information of the wireless master device 70 and the like.

The analysis result includes, as its item, a value obtained by the analysis unit 32 that analyzes the sound detected by the detection unit 31 based on the learning result N. As described above, the degree of difference between the data collected when the inspection target object 50 is in the normal state and the data currently collected from the inspection target object 50 is used as the analysis result.

Next, an example of a hardware configuration of the computers 100 and 110 that configure each device of the automatic inspection system 1 will be described with reference to FIGS. 4 and 5.

FIG. 4 is a block diagram showing an example of a hardware configuration of the computer 100 that configures the wireless slave device 30. Since an example of the hardware configuration of the computer 100 that configures the wireless slave device 30′ is similar to that of the wireless slave device 30, in the following description, an example of the hardware configuration of the computer 100 that configures the wireless slave device 30 will be described mainly with reference to the wireless slave device 30.

The computer 100 is hardware used as a computer for use in the wireless slave device 30. The computer 100 includes a Micro Processing Unit (MPU) 101, a main storage device 102, an auxiliary storage device 103, and a bus 104. Further, the computer 100 includes the microphone 105, an input and output circuit 106, a communication circuit 107, and the built-in battery 108. The blocks are communicably connected to each other through the bus 104.

The MPU 101 reads out a program code of software for realizing the function of the wireless slave device 30 according to the present embodiment from the auxiliary storage device 103, loads the program code into the main storage device 102, and executes the program code. Accordingly, the auxiliary storage device 103 stores a program for operating the computer 100, in addition to a boot program and various parameters. The auxiliary storage device 103 permanently stores programs, data, and the like necessary for operating the MPU 101, and is used as an example of a non-transitory computer-readable recording medium storing the program executed by the computer 100. As the auxiliary storage device 103, a nonvolatile memory such as a semiconductor memory is used.

In the main storage device 102, variables, parameters, and the like generated during the arithmetic processing of the MPU 101 are temporarily written, and these variables, parameters, and the like are read out by the MPU 101 as appropriate. In the wireless slave device 30, the functions of each unit in the wireless slave device 30 are realized by the MPU 101 executing the program. In addition, in the wireless slave device 30, the digital value obtained by the conversion of the analog signal received from the detection unit 31 (microphone 105) is temporarily stored in the auxiliary storage device 103, and the analysis result of the analysis unit 32 is also temporarily stored in the auxiliary storage device 103.

The microphone 105 is a device that collects a sound generated by the inspection target object 50. Here, it is known that when an abnormality starts to occur in the inspection target object 50, the sound in an ultrasound region higher than the audible region is generated. Accordingly, the microphone 105 may have a function capable of collecting not only the audible sound, but also the sound outside the audible region, for example, the ultrasound waves generated by the inspection target object 50. The wireless master device 70 can easily and accurately manage the occurrence of an abnormality in the inspection target object 50 at an early stage based on the analysis results obtained by the wireless slave device 30 collecting and analyzing the ultrasound waves emitted from the inspection target object 50.

The input and output circuit 106 is an interface for inputting and outputting analog signals. It has a function of outputting an analog signal input from the microphone 105 to an AD converter (not shown) of the analysis unit 32. When the computer 100 configures the wireless relay device 60, the microphone 105 and the input and output circuit 106 are unnecessary.

For the communication circuit 107, a low-power wireless module for Network Interface Card (NIC) or Internet of Things (IoT) is used, for example, and various types of data may be transmitted and received between devices through a wireless communication path such as a wireless local area network (LAN), a multi-hop low-power wireless communication, and the like connected to the NIC. In the wireless slave device 30, the communication circuit 107 operates to transmit the learning data N to the setting device 20 and receive the learning result N from the setting device 20. Further, in the wireless slave device 30, the wireless communication unit 33 may control the operation of the communication circuit 107 to transmit the packet D1 to the wireless relay device 60 and to transfer the packet D1 received from another wireless slave device 30 to the wireless relay device 60.

The built-in battery 108 is mounted on the wireless slave device 30 and supplies power to each unit in the computer 100 in accordance with the control of the power supply unit 34 shown in FIG. 1. Although it is assumed that the built-in battery 108 according to the present embodiment is a primary battery, the built-in battery 108 according to a second embodiment described below may be a secondary battery.

FIG. 5 is a block diagram showing an example of a hardware configuration of the computer 110 that configures the analysis management device 10, the setting device 20, the wireless relay device 60, the wireless master device 70, and the monitoring terminal 80.

The computer 110 is the hardware that is used as a computer for use in the analysis management device 10, the setting device 20, the wireless relay device 60, the wireless master device 70, and the monitoring terminal 80. The computer 110 includes an MPU 111, a main storage device 112, an auxiliary storage device 113, a bus 114, a communication circuit 115, and a user interface device 116. The blocks are communicably connected to each other through the bus 114.

The MPU 111 reads out, from the auxiliary storage device 113, a program code of software for realizing the functions of the analysis management device 10, the setting device 20, the wireless relay device 60, the wireless master device 70, and the monitoring terminal 80 according to the present embodiment, loads the program code into the main storage device 112, and executes the program code. Note that, in the computer 110, a Central Processing Unit (CPU) may be used instead of the MPU 111.

In the main storage device 112, variables, parameters, and the like generated during the arithmetic processing of the MPU 111 are temporarily written, and these variables, parameters, and the like are read out by the MPU 111 as appropriate. In the analysis management device 10, the functions of the characteristic value extraction unit 15, the similarity selection unit 16, and the registration unit 18 are realized by the MPU 111. In the setting device 20, the functions of the learning data transfer unit 21, the prediction notification unit 22, the background information registration unit 23, and the learning result setting unit 24 are realized by the MPU 111. In the wireless relay device 60, the function of transferring the packet D1 received from the wireless slave device 30 to the wireless master device 70 is realized by the MPU 111. In the wireless master device 70, the function of capturing the packet D1 transferred from the wireless relay device 60 and publishing various data extracted by the MPU 111 from the data part of the packet D1 to the monitoring terminal 80 is realized by the MPU 111. In addition, in the monitoring terminal 80, the function of receiving the data published by the wireless master device 70 and presenting the data to the operator through the user interface device 116 is realized by the MPU 111.

For the auxiliary storage device 113, a hard disk drive (HDD), a solid state drive (SSD), a flexible disk, an optical disk, a magneto-optical disk, a CD-ROM, a CD-R, a magnetic tape, a nonvolatile memory, and the like are used, for example. The auxiliary storage device 113 stores a program for operating the computer 110, in addition to the OS and various parameters. The auxiliary storage device 113 permanently stores programs, data, and the like necessary for operating the MPU 111, and is used as an example of a non-transitory computer-readable recording medium storing the program executed by the computer 110. In the analysis management device 10, the functions of the temporary storage unit 17 and the registration database 19 are realized by the auxiliary storage device 113. In the wireless master device 70, the function of storing various data extracted from the data part of the packet D1 is realized by the auxiliary storage device 113. In the monitoring terminal 80, the function of accumulating the analysis result transmitted from the wireless master device 70 is realized by the auxiliary storage device 113.

In the communication circuit 115, an NIC and the like is used for the monitoring terminal 80, for example, and various types of data may be transmitted and received between the devices through a wireless communication path such as a wireless LAN connected to the NIC or a wired communication path. The analysis management device 10 may control the operation of the communication circuit 115 to receive the learning data N and the background information N from the setting device 20 or to transmit the learning result N and the background information A to the setting device 20. In addition, the setting device 20 may control the operation of the communication circuit 115 to transmit the learning data N and the background information N to the analysis management device 10, transmit the learning result N to the wireless slave device 30, and receive the learning result N and the background information A from the analysis management device 10. In the wireless relay device 60 and the wireless master device 70, a low-power wireless module for IoT and the like is used for the communication circuit 115. The wireless relay device 60 may control the operation of the communication circuit 115 to transfer the packet D1 received from the wireless slave device 30 to the wireless master device 70. The wireless master device 70 controls the operation of the communication circuit 115 to receive the packet D1 transmitted from the wireless relay device 60. The wireless master device 70 may transmit various data to the monitoring terminal 80 through the communication circuit 115. In the monitoring terminal 80, a wireless communication unit (not shown) controls the operation of the communication circuit 115 to receive various data transmitted from the wireless master device 70.

For the user interface device 116, a liquid crystal display monitor, a touch panel device, a mouse, a keyboard, and the like are used, for example. The operator may confirm the data displayed on the user interface device 116 and input various commands through the user interface device 116. The user interface device 116 is provided mainly in the setting device 20 and the monitoring terminal 80. The user interface device 116 of the setting device 20 displays information (for example, prediction notification shown in FIG. 8) for which the prediction notification unit 22 performs the prediction notification, and enables the installation worker 90 to edit the background information A and to instruct the wireless slave device 30 to set the learning result N. The analysis management device 10, the wireless relay device 60, and the wireless master device 70 may not be provided with the user interface device 116.

When there is no power supply from an external power supply to the wireless relay device 60, the wireless relay device 60 may also include a built-in battery.

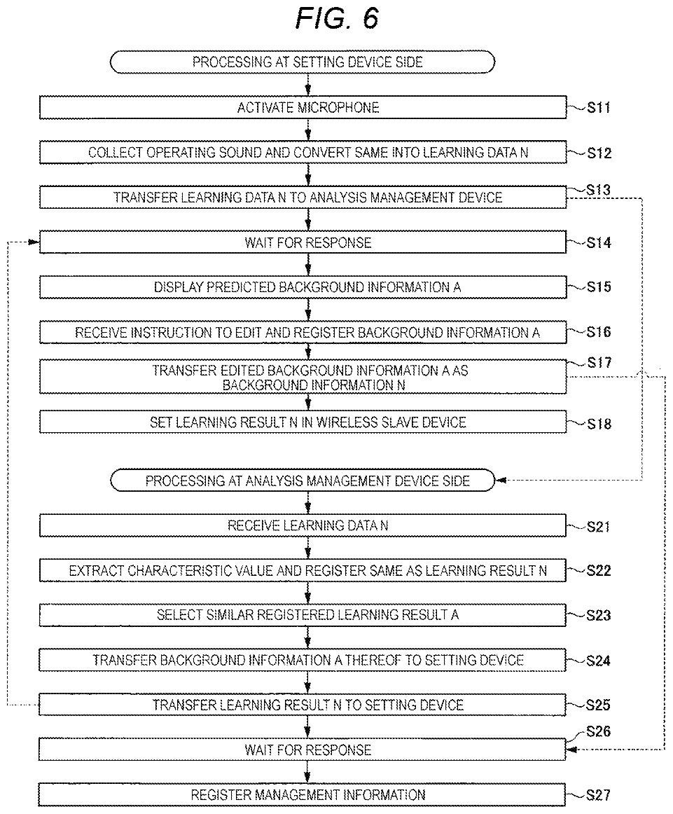

Next, an example of a process executed by the setting device 20 and the analysis management device 10 will be described with reference to FIG. 6.

FIG. 6 is a flowchart showing the process executed by the setting device 20 and the analysis management device 10.

The wireless slave device 30 supplies power from the power supply unit 34 to the detection unit 31 and activates the microphone 105 (labeled as “microphone” in the drawing) (S11). Then, the detection unit 31 starts to collect the operating sounds of the inspection target object 50. The operating sounds collected by the detection unit 31 and converted into electric signals are input to the analysis unit 32.

The analysis unit 32 samples the sound data of the analog signal input from the detection unit 31 and converts the data into learning data N which is digital information of the sounds (S12). Then, the learning data N is transferred to the analysis management device 10 (S13), and a response from the analysis management device 10 is waited (S14).

When receiving the learning data N from the setting device (S21), the analysis management device 10 causes the characteristic value extraction unit 15 to extract a characteristic value from the learning data N, and newly registers the characteristic value as the learning result N in the temporary storage unit 17 (S22). Next, the similarity selection unit 16 selects the learning result A registered in the registration database 19, which is similar to the learning result N (S23). Then, the similarity selection unit 16 transfers the background information A and the learning result N associated with the selected learning result A, to the setting device 20 (S24, S25). Thereafter, the analysis management device 10 waits for a response from the setting device 20 (S26).

When receiving the background information A and the learning result N transferred from the analysis management device 10, the prediction notification unit 22 of the setting device 20 shows the background information A as the predicted background information to the installation worker 90 (S15), and receives an instruction to edit and register the background information A (S16). The background information A edited by the installation worker 90 becomes the newly registered background information N and is transferred to the analysis management device 10 (S17). In addition, when a setting instruction is received from the installation worker 90, the learning result N is set in the analysis unit 32 of the wireless slave device 30 (S18).

When receiving the background information N from the setting device 20, the registration unit 18 of the analysis management device 10 registers the background information N in the registration database 19 in association with the learning result N and the learning data N (S27). In the present embodiment, the background information N, the learning result N, and the learning data N as a set of set data are collectively referred to as “management information”.

For a new inspection target object 50 that has not been monitored by the wireless slave device 30 in the past, the registration database 19 has no learning data 11, learning result 12, or the background information 13 that was registered in the past. In this case, since the learning data N and the learning result N generated by the wireless slave device 30 have no past information to be compared with, the learning data N and the learning result N including the background information N are newly registered in the registration database 19.

FIG. 7 shows an example of the background information 13 registered in the registration database 19.

The background information 13 includes an identification number of the wireless slave device 30. Further, the background information 13 includes physical information that can be automatically updated by a Global Positioning System (GPS) or the like, such as the year, month, and day when the wireless slave device was installed, and position information indicating the installation position of the wireless slave device 30.

The background information 13 also includes information that facilitates the identification of the target, such as the type of the inspection target object 50. Further, the background information 13 may include image information such as an explanatory image (for example, a photograph showing the installation status) and an explanatory image of a sound (for example, time-series power spectrum diagram of the sound). The installation worker 90 may perform editing to add or reduce such information by using a general application program that runs on the setting device 20, and register the information in the registration database 19.

Since the background information 13 includes an image such as a time-series power spectrum diagram, the operator who operates the automatic inspection system 1 may easily visually confirm the difference in the time-series change between the sound at the normal time and the sound at the abnormal time. Therefore, the time required for the operator to confirm the background information 13 may be reduced. Note that the characteristic value extraction unit 15 may output to the prediction notification unit 22 the time-series power spectrum diagram that is obtained by processing the learning data N input to the analysis management device 10.

In addition, the background information 13 also includes data indicating the summary of the sound generated by the inspection target object 50, such as the average of the sound pressure, the variation range of the sound pressure (the magnitude of the beat), and the variation cycle of the sound pressure (the beat cycle) as shown in FIG. 2. Further, the background information 13 also includes an item such as degree of abnormality at the time of installation of the wireless slave device 30 and comment in text. As the degree of abnormality at the time of installation of the wireless slave device 30, the opinion, know-how, and the like of the installation worker 90 when installing the wireless slave device 30 on the inspection target object 50 are recorded, for example.

For example, when the inspection target object 50 is immediately before the overhaul, the installation worker 90 hears the sound generated from the inspection target object 50 and sets the degree of abnormality at the time of installation by inputting “abnormal” for the condition of the inspection target object 50. In addition, when the inspection target object 50 is immediately after the overhaul, the installation worker 90 hears the sound generated from the inspection target object 50 and sets the degree of abnormality at the time of installation by inputting “normal” for the condition of the inspection target object 50. Further, the installation worker 90 may also record, in the comment text item, the timing of the overhauls, such as whether the inspection target object 50 is immediately before or immediately after the overhaul.

FIG. 8 shows an example of a prediction notification indicated by the prediction notification unit 22.

The prediction notification unit 22 may rank the registered background information A associated with the learning data A with a higher degree of similarity to the learning data N, and perform the prediction notification of the background information A in descending order of rank. Accordingly, based on the predicted and notified background information A with a high degree of similarity, the installation worker 90 confirms whether or not the inspection target object 50 installed with the wireless slave device 30 is the same model as the other previously-learned inspection target objects 40, and whether or not the learning result A set for the other wireless slave devices 30 can be set for the wireless slave device 30 from which the learning data N is currently acquired.

Then, the installation worker 90 may determine whether the background information A may be registered in the analysis management device 10 in association with the learning result N based on the content of the predicted notification. As described above, when the background information A is insufficient, or when it is different from the content of the currently-installed wireless slave device 30, the installation worker 90 may edit the background information A and issue an instruction to register the edited background information N in the analysis management device 10.

The operator who operates the automatic inspection system groups the inspection target objects having the same type information included in the background information 13 and obtains the typical data 14 registered in the registration database 19. Thereby, the quantity and quality of the learning data 11 may be expanded, and the accuracy of the feature quantity may be increased. In addition, when a new characteristic value is generated, the validity of the characteristic value may be verified in comparison with the degree of abnormality at the time of installation included in the background information 13.

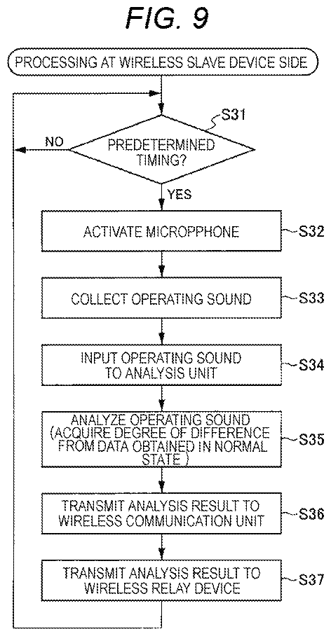

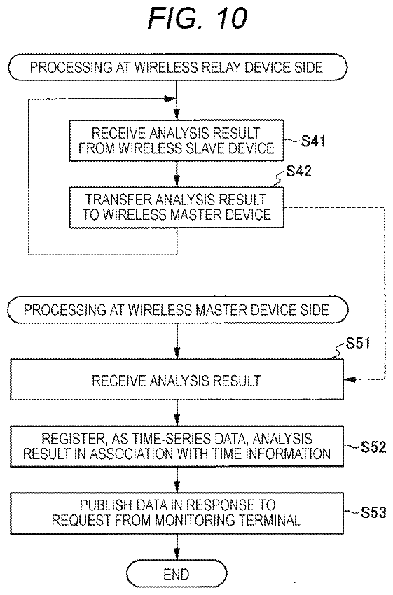

Next, an example of a process executed by the wireless slave device 30, the wireless relay device 60, and the wireless master device 70 will be sequentially described with reference to FIGS. 9 and 10.

FIG. 9 is a flowchart showing an example of the process executed by the wireless slave device 30.

The wireless slave device 30 monitors to see whether a predetermined timing has elapsed (S31). When the predetermined timing has not elapsed (S31: NO), the wireless slave device 30 continues to monitor the elapse of the timing again.

When the predetermined timing has elapsed (S31: YES), the wireless slave device 30 causes the power supply unit 34 to supply power to the detection unit 31, and activates the microphone 105 (labeled as “microphone” in the drawing) (S32). The predetermined timing may be a fixed cycle or may be an irregular cycle. Further, the wireless slave device 30 may set a predetermined timing in accordance with an instruction from the wireless master device 70 transmitted to the wireless slave device 30 through the wireless relay device 60.

The detection unit 31 collects the operating sound of the inspection target object 50 (S33). The operating sounds collected by the detection unit 31 and converted into analog electric signals (analog signals) are input to the analysis unit 32 (S34).

The analysis unit 32 converts the analog signal input from the detection unit 31 into learning data N, and analyzes the learning data N based on a learning result N set in advance. Thereafter, the analysis unit 32 acquires, as an analysis result, the degree of difference between the data obtained from the inspection target object 50 in a normal state and the data currently collected from the inspection target object 50 (S35). Then, the analysis unit 32 transmits the analysis result to the wireless communication unit 33 (S36).

The wireless communication unit 33 generates a packet D1 based on the analysis result received from the analysis unit 32, and transmits the packet D1 to the wireless relay device 60 (S37).

FIG. 10 is a flowchart showing an example of a process executed by the wireless relay device 60 and an example of a process executed by the wireless master device 70.

First, the process of the wireless relay device 60 will be described.

When receiving the packet D1 including the analysis result from the wireless slave device 30 (S41), the wireless relay device 60 transfers the packet D1 including the analysis result to the wireless master device 70 (S42). The packet D1 transmitted from the wireless slave device 30 reaches the wireless master device 70, either directly or via another device, according to the network address or the identification information included in the header.

When receiving the packet D1 including the analysis result from the wireless slave device 30 through the wireless relay device 60 (S51), the wireless master device 70 extracts the analysis result from the packet D1 and converts the extracted analysis result into data (S52). By the data conversion, it means that the packet D1 is registered in the wireless master device 70 as time-series data by storing the time information of the time at which the packet D1 was collected and the analysis result in association with each other.

Thereafter, the wireless master device 70 transmits time-series data (an example of an analysis result) in response to a request from the monitoring terminal 80, and the monitoring terminal 80 determines the state of the inspection target object 50 from the analysis result and publishes the same (S53). In the monitoring terminal 80, the time-series data published in response to the request is displayed on a predetermined user interface of the user interface device 116.

In the automatic inspection system 1 according to the first embodiment described above, when the wireless slave device 30 is installed on the inspection target object 50, the learning result N may be set in the wireless slave device 30 through the setting device 20. Here, the setting device 20 causes the analysis management device 10 to perform the learning process by transferring the learning data N received from the wireless slave device 30 to the analysis management device 10. Accordingly, the wireless slave device 30 and the setting device 20 are not required to perform the learning process with a high load. In addition, the analysis management device 10 sets a new learning result N obtained by extracting the characteristic value of the learning data N received from the setting device 20 in the wireless slave device 30 through the setting device 20. Accordingly, the wireless slave device 30 may transmit the degree of difference from the normal sound as an analysis result to the wireless master device 70 through the wireless relay device 60 by using the learning result N.

In addition, even when the wireless slave device A is installed in the equipment in various environments, as long as the background information A is the same, the analysis management device 10 may set the previously-registered learning result A in the wireless slave device 30 by using the background information A at the time of installation of the wireless slave device 30. In other words, by utilizing the learning result A set for a certain wireless slave device 30, the setting device 20 may also set the learning result A for other wireless slave devices 30. When the learning result A can be utilized, the processing load on the analysis management device 10 may be reduced. Further, even when many wireless slave devices 30 are installed in the plant, since the learning result A can be set in the wireless slave device 30 and utilized, a company that installs the wireless slave devices 30 may save the time required to install a large number of wireless slave devices 30.

Further, the analysis management device 10 obtains a new characteristic value extracted from the learning data N as a learning result N by matching the learning data N transmitted from the wireless slave device 30 with the typical data 14. Accordingly, the accuracy of the characteristic value obtained from the learning data N transmitted from the wireless slave device 30 may be increased.

The background information A associated with the learning data A similar to the learning data N is predicted and notified to the installation worker 90 by the prediction notification unit 22 of the setting device 20 to determine the validity of the learning result N set in the wireless slave device 30. When the background information A is different from the status in which the wireless slave device 30 is actually installed, the installation worker 90 generates the background information N by editing the background information A. Then, the analysis management device 10 is instructed to register the background information N in the registration database 19, so that the learning data N, the learning result N, and the background information N are registered in the registration database 19 as a set of management information. Accordingly, the learning result N set when the wireless slave device 30 is installed on the inspection target object 50 and the learning data N and the background information N associated with the learning result N may be used as the learning result A, the learning data A, and the background information A, respectively, when the wireless slave device 30 is installed on another inspection target object 50.

The timing at which the learning result N is set in the analysis unit 32 of the wireless slave device 30 is not limited to the time when the wireless slave device 30 is installed on the inspection target object 50. For example, when the inspection target object 50 is re-installed after overhauling, there is a high possibility that the sound generated by the inspection target object 50 changes. In such a case, the learning result N may be set again with respect to the wireless slave device 30 installed on the inspection target object 50.

In addition, when another equipment is installed around the inspection target object 50 and a sound different from the sound registered as the background information 13 is generated from this equipment, the analysis unit 32 is likely to output an analysis result indicating that the degree of difference from the normal sound has increased to the inspection target object 50. Therefore, the learning result N is preferably set again in the analysis unit 32 of the wireless slave device 30 when the surrounding environment changes after the wireless slave device 30 is installed. In addition, the background information 13 shown in FIG. 7 may record a change in the environment around the inspection target object 50 or the presence of a sound generated by the equipment other than the inspection target object 50.

In addition, the wireless slave device 30 activates the detection unit 31 at regular intervals (for example, every 10 minutes, every hour), causes the detection unit 31 to detect the state of the inspection target object 50, and obtains an analysis result of the state of the inspection target object 50. The automatic inspection system 1 does not transmit the entire sound data of the frequency band in which the detection unit 31 can collect sound from the wireless slave device 30 to the wireless master device 70, but transmits a packet D1 including the degree of difference from the normal sound as an analysis result to the wireless master device 70. Accordingly, the data size of the packet D1 of the analysis result transmitted from the wireless slave device 30 to the wireless master device 70 may be smaller than the data size of the sound data collected by the detection unit 31 as it is.

In addition, the wireless slave device 30 is intermittently driven, and transmits a packet D1 of a minimum size from which the wireless master device 70 can extract the analysis result, so that the power consumption of the wireless slave device 30 may be reduced. Therefore, the wireless slave device 30 may reduce the power energy required for one transmission of the analysis result, and suppress the power consumption of the built-in battery 108. As a result, the life of the built-in battery 108 of the wireless slave device is prolonged, thereby reducing the frequency of battery replacement of the wireless slave device 30. Accordingly, a company adopting the wireless slave device 30 may reduce the labor for maintenance of the wireless slave device 30.

In addition, the wireless master device 70 notifies the monitoring terminal 80 that an abnormality has occurred in the inspection target object 50 based on the analysis result included in the packet D1 transmitted by the wireless slave device 30. Therefore, the operator using the monitoring terminal 80 may remotely monitor the state of the inspection target object 50, and may reduce the risk of having to approach the inspection target object 50 to inspect the inspection target object 50. Therefore, it is possible to not only reduce the operation cost of the inspection target object 50, but also improve the usability of the automatic inspection system 1.

The automatic inspection system 1 may be configured such that, when the wireless master device 70 is within a range in which the wireless slave device 30 can communicate, the wireless relay device 60 is not provided, and the wireless slave device 30 directly communicates with the wireless master device 70.

Further, the detection unit 31 may be configured to include an AD converter. In this case, the detection unit 31 performs sampling and quantization with respect to the amplitude of the analog signal of the collected sound, converts the analog signal into a digital value, and outputs the digital value to the analysis unit 32. Accordingly, the analysis unit 32 may be configured without the AD converter.

[Example of Configuration with Microphone Separated from Wireless Slave Device]

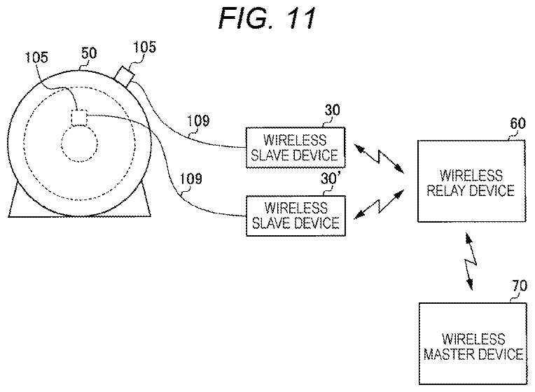

FIG. 11 is a diagram showing an example of a place where the wireless slave device 30 is mounted.

The wireless slave device 30 shown in FIG. 1 incorporates the detection unit 31, and the wireless slave device 30 is installed at a position separated away from the inspection target object 50. However, as shown in FIG. 11, the detection unit 31 provided in the wireless slave device 30 may be configured to be detached from the housing of the wireless slave device 30, separated away from the wireless slave device 30, and attached to the inspection target object 50. In this manner, the configuration in which the detection unit 31 is separated away from the housing of the wireless slave device 30 and attached to the inspection target 50 is applied when the detection unit 31 (for example, the microphone 105, and a thermocouple and a vibration sensor described below) that contacts the inspection target 50 and detects the state of the inspection target 50 is used.

Since the size of the detection unit 31 (microphone 105) is smaller than the housing of the wireless slave device 30, it may be directly attached to the inspection target object 50. For example, when the inspection target object 50 is a rotating machine, the detection unit 31 may be directly attached to a bearing of the rotating machine or the outside of the rotating machine cover. The detection unit 31 is directly attached to each part of the rotating machine in this manner, so that the sound collected by the detection unit 31 is less likely to be affected by the environmental sound around the installed rotating machine.

The detection unit 31 and the wireless slave device 30 are connected with a power line and a signal line extended from the wireless slave device 30. The power line and the signal line are incorporated in a cable 109 connecting the detection unit 31 and the wireless slave device 30. The detection unit 31 operates with power supplied from the power supply unit 34 (built-in battery 108) through the power line. In addition, the detection unit 31 outputs an analog signal of the sound collected from the inspection target object 50 to the analysis unit 32 of the wireless slave device 30 through the signal line. The analysis unit 32 may analyze the sound based on the analog signal of the sound generated only from the inspection target object 50, while excluding the surrounding noise.

### [First Exemplary Configuration of Multi-Hop Network (Single Manager)]

FIG. 12 is a diagram showing a first exemplary configuration of the multi-hop network (single manager) of the automatic inspection system 1 according to the first embodiment.

As shown in FIG. 1, the automatic inspection system 1 includes a plurality of wireless slave devices 30 and 30′ and the wireless relay device 60. Usually, the wireless relay device 60 is predetermined as the first destination of the packet D1 transmitted by the wireless slave devices 30 and 30′. However, the environment in which the wireless slave devices 30 and 30′ are installed is often in a plant where equipments of various shapes are arranged. Accordingly, when the equipment 55 is newly installed since the wireless slave devices 30 and 30′ has been installed, the packet D1 cannot be transmitted from the wireless slave device 30 to the wireless relay device 60.

Here, a multi-hop network according to a first exemplary configuration configured by the automatic inspection system 1 will be described. In the multi-hop network, a plurality of wireless slave devices 30 and 30′ are able to transfer the packet D1. An example is shown, in which a plurality of wireless slave devices 30(1) to 30(4) are provided in a multi-hop network, with the wireless slave devices 30 being added with reference numerals (1) to (4) to identify the plurality of wireless slave devices 30 and 30′. In addition, an example is shown, in which wireless relay devices 60(1) and 60(2) are provided in a multi-hop network, with the wireless relay devices being added with reference numerals (1) and (2) to identify a plurality of wireless relay devices 60.

The wireless slave device 30(1) collects sound generated from the inspection target object A51, and the wireless slave device 30(2) collects sound generated from the inspection target object B52. Then, the wireless slave devices 30(3) and 30(4) collect sounds generated from different positions of the inspection target object C53. For example, the packets D1 are transmitted from the two wireless slave devices 30(1) and 30(2) to the wireless relay device 60(1) shown on the left side of FIG. 12. Further, it is assumed that the packets D1 are also transmitted from the two wireless slave devices 30(3) and 30(4) to the wireless relay device 60(2) shown on the right side of FIG. 12.

However, since the equipment 55 is installed between the wireless relay device 60(2) and the two wireless slave devices 30(3) and 30(4) shown on the right side of FIG. 12, it is assumed that the wireless relay device 60(2) and the two wireless slave devices 30(3) and 30(4) cannot directly communicate with each other. As described above, among the plurality of wireless slave devices 30(1) to 30(4), when it is detected that the wireless slave devices 30(3) and 30(4) cannot transmit the packet D1 to the wireless relay device 60(2), transfer of the packet D1 is requested to another wireless slave device 30(2) that is capable of transmitting data to another wireless relay device 60(1).

Therefore, the wireless slave devices 30(3) and 30(4) that cannot transmit the packet D1 to the wireless relay device 60(2) search for the wireless slave devices 30(1) and 30(2) that can transmit the packet D1 to another wireless relay device 60(1). The wireless slave devices 30(3) and 30(4) that cannot transmit the packet D1 transfer the packet D1 to the wireless slave device 30(2) that can transmit the packet D1. At this time, the wireless slave device 30(3) transmits its own packet D1 to the wireless slave device 30(2), and further transfers the packet D1 transmitted from the wireless slave device 30(4) to the wireless slave device 30(2).

Then, the other wireless slave device 30(2) transfers the packet D1 transmitted from the wireless slave devices 30(3) and 30(4) to the wireless relay device 60(1). That is, the wireless slave device 30(2) transmits its own packet D1 to the wireless relay device 60(1), and also transmits the packet D1 transmitted or transferred from the wireless slave device 30(3) to the wireless relay device 60(1). As described above, the automatic inspection system. 1 configures the multi-hop network, so that all the wireless slave devices 30(1) to 30(4) may transmit the packet D1 to the wireless master device 70 through the wireless relay device 60.

When the wireless slave devices 30(2) and 30(3) continue to transfer the packet D1 for a long period of time, the power consumption of the built-in battery 108 of the wireless slave devices 30(2) and 30(3) is increased to exceed that of the other wireless slave devices 30(1) and 30(4). Therefore, the presence of the wireless slave device 30(2) which has started transferring the packet D1 transmitted from the other wireless slave devices 30(3) and 30(4) may be notified to the monitoring terminal 80 through the wireless master device 70(1). By this notification, the operator may know the status in which the wireless slave devices 30(3) and 30(4) and the wireless relay device 60(2) cannot communicate with each other wirelessly. Then, the operator may take measures such as moving the wireless slave devices 30(3) and 30(4) to a position where communication with the wireless master device 60(2) is available, moving the equipment 55, or the like.

The monitoring terminal 80 may monitor through the external Internet the state of the inspection target object 50 at a location away from the plant where the inspection target object 50 is installed.

### [Example of Second Exemplary Configuration of Multi-Hop Network (Multi-Manager)]

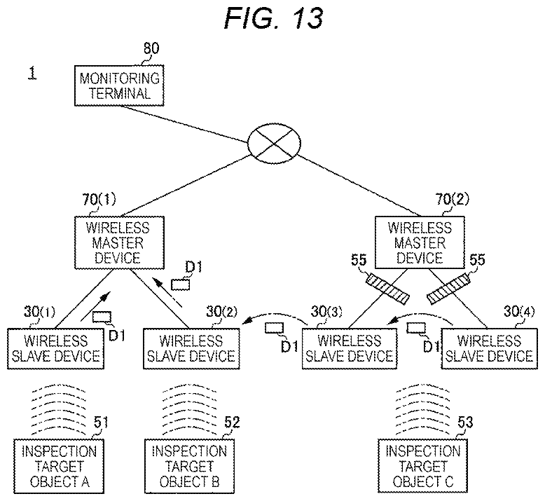

FIG. 13 is a diagram showing a second exemplary configuration of the multi-hop network (multi-manager) of the automatic inspection system 1 according to the first embodiment.

Here, a multi-hop network according to the second exemplary configuration configured by the automatic inspection system 1 will be described. The automatic inspection system 1 may configure a multi-hop network in a form that excludes the wireless relay device 60. An example is shown, in which wireless master devices 70(1) and 70(2) are provided in a multi-hop network, with the wireless master devices being added with the reference numerals (1) and (2) to identify the plurality of wireless master devices 70. That is, this multi-hop network is configured by replacing the wireless relay devices 60(1) and 60(2) shown in FIG. 1 with two wireless master devices 70(1) and 70(2). The wireless master devices 70(1) and 70(2) are connected to the monitoring terminal 80 through a communication network such as the Internet.

In the multi-hop network, a plurality of wireless slave devices 30 and 30′ are able to transfer the packet D1. For example, the packets D1 are transmitted from the two wireless slave devices 30(1) and 30(2) to the wireless master device 70(1) shown on the left side of FIG. 13. Further, it is assumed that the packets D1 are also transmitted from the two wireless slave devices 30(3) and 30(4) to the wireless relay device 70(2) shown on the right side of FIG. 13.

However, since the equipment 55 are installed between the wireless master device 70(2) and the two wireless slave devices 30(3) and 30(4) shown on the right side of FIG. 13, it is assumed that the wireless master device 70(2) and the two wireless slave devices 30(3) and 30(4) cannot directly communicate with each other. As described above, among the plurality of wireless slave devices 30(1) to 30(4), when it is detected that the wireless slave devices 30(3) and 30(4) cannot transmit the packet D1 to the wireless master device 70(2), transfer of the packet D1 is requested to another wireless slave device 30(2) that is capable of transmitting data to another wireless master device 70(1).

Therefore, the wireless slave devices 30(3) and 30(4) that cannot transmit the packet D1 to the wireless master device 70(2) search for the wireless slave devices 30(1) and 30(2) that can transmit the packet D1 to another master device 70(1). The wireless slave devices 30(3) and 30(4) that cannot transmit the packet D1 transfer the packet D1 to the wireless slave device 30(2) that can transmit the packet D1. At this time, the wireless slave device 30(3) transmits its own packet D1 to the wireless slave device 30(2), and further transfers the packet D1 transmitted from the wireless slave device 30(4) to the wireless slave device 30(2).

Then, the other wireless slave device 30(2) transfers the packet D1 transmitted from the wireless slave devices 30(3) and 30(4) to the wireless master device 70(1). That is, the wireless slave device 30(2) transmits its own packet D1 to the wireless master device 70(1), and also transmits the packet D1 transmitted or transferred from the wireless slave device 30(3) to the wireless master device 70(1). As described above, the automatic inspection system 1 configures the multi-hop network, so that all the wireless slave devices 30(1) to 30(4) may transmit the packet D1 to the monitoring terminal 80 through the wireless master device 70(1).

When the wireless slave devices 30(2) and 30(3) continue to transfer the packet D1 for a long period of time, the power consumption of the built-in battery 58 of the wireless slave devices 30(2) and 30(3) is increased to exceed that of the other wireless slave devices 30(1) and 30(4). Therefore, the presence of the wireless slave device 30(2) which has started transferring the packet D1 transmitted from the other wireless slave devices 30(3) and 30(4) may be notified to the monitoring terminal 80 through the wireless master device 70(1). By this notification, the worker may know the status in which the wireless slave devices 30(3) and 30(4) and the wireless master device 70(2) cannot communicate with each other wirelessly. Then, the worker may take measures such as moving the wireless slave devices 30(3) and 30(4) to a position where communication with the wireless master device 70(2) is available, moving the equipment 55, or the like.

### [Third Exemplary Configuration of Multi-Hop Network (Multi-Manager)]

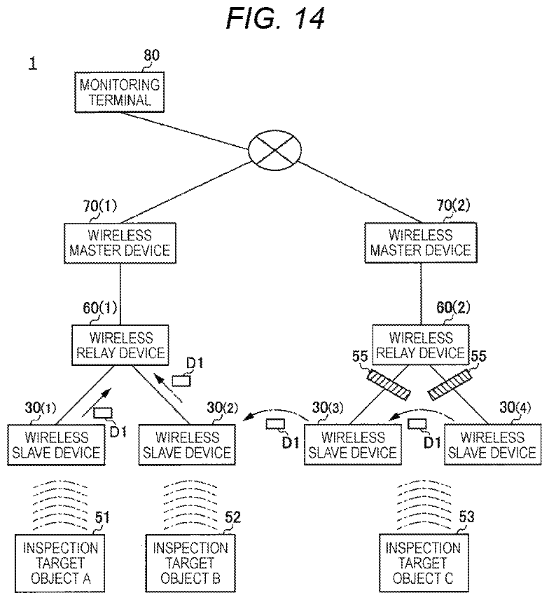

FIG. 14 is a diagram showing a third exemplary configuration of the multi-hop network (multi-manager) of the automatic inspection system 1 according to the first embodiment.

Here, a multi-hop network according to a third exemplary configuration configured by the automatic inspection system 1 will be described. The multi-manager configuration of the multi-hop network according to the example of the second configuration shown in FIG. 13 may include a wireless relay device 60 as shown in FIG. 14.

The automatic inspection system 1 shown in FIG. 14 may configure a multi-hop network in a form that includes a plurality of wireless relay devices 60 and a plurality of wireless master devices 70. In this multi-hop network, the wireless relay device 60(1) is connected to the wireless slave devices 30(1) and 30(2), and the wireless relay device 60(2) is connected to the wireless slave devices 30(3) and 30(4). Then, the wireless relay device 60(1) and the wireless master device 70(1) are connected to each other, and the wireless relay device 60(2) and the wireless master device 70(2) are connected to each other. The wireless master devices 70(1) and 70(2) are connected to the monitoring terminal 80 through a communication network such as the Internet.

Also in the multi-hop network according to a third exemplary configuration, the equipment 55 is installed between the wireless slave devices 30(3) and 30(4) and the wireless relay device 60(2), and the wireless relay device 60(2) and the two wireless slave devices 30(3) and 30(4) cannot directly communicate with each other. In this case, the wireless slave devices 30(3) and 30(4) search for another wireless slave device 30(2). Then, the wireless slave device 30(4) transmits the packet D1 to the wireless slave device 30(3). The wireless slave device 30(3) transmits the packet D1 created by the wireless slave device 30(3) itself to the wireless slave device 30(2), and transfers the packet D1 received from the wireless slave device 30(4) to the wireless slave device 30(2). Thereafter, the wireless slave device 30(2) transfers the packet D1 to the wireless relay device 60(1), so that the packet D1 of the wireless slave devices 30(3) and 30(4) is transmitted from the wireless relay device 60(1) to the wireless master device 70(1), and transmitted from the wireless master device 70(1) to the monitoring terminal 80 through the communication network.

As described above, the automatic inspection system 1 configures the multi-hop network according to the third exemplary configuration, so that all of the wireless slave devices 30(1) to 30(4) may transmit the packet D1 to the monitoring terminal 80 through the wireless relay device 60(1) and the wireless master device 70(1). In order to prevent the transfer of the packet D1 from continuing for a long period of time, the process in which the wireless master device 70(1) notifies the monitoring terminal that the wireless slave devices 30(2), (3) have started transferring the packet D1 is the same as in the multi-hop network according to the first exemplary configuration.

### Second Embodiment

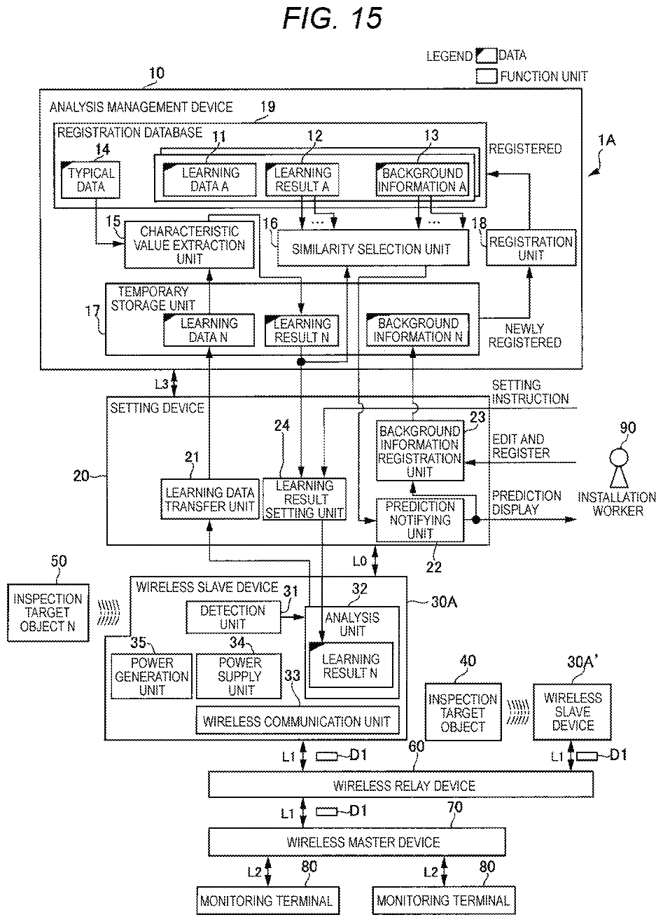

Next, an exemplary configuration and an exemplary operation of an automatic inspection system according to a second embodiment of the present disclosure will be described with reference to FIG. 15.

FIG. 15 is a block diagram showing an exemplary configuration of an automatic inspection system 1A according to the second embodiment. In the present embodiment, a power generation unit 35 is provided in the wireless slave device 30, which enables to suppress the consumption of the built-in battery 108 of the power supply unit 34. The detailed description of the wireless slave device 30A′ having the same configuration as that of the wireless slave device 30A, and the detailed description of the same parts as those of the wireless relay device 60, the wireless master device 70, and the monitoring terminal 80 according to the first embodiment will be omitted.

The wireless slave device 30A according to the second embodiment further includes the power generation unit 35. The power generation unit 35 is configured to include a piezoelectric vibrator and the like, for example, and is a device that generates power by converting vibration due to sound waves emitted from the inspection target object 50 or vibration generated from the inspection target object 50 into electric energy (electric power). The power generated by the power generation unit 35 is supplied to the power supply unit 34.

The power supply unit 34 may supply (feed) both the power supplied from the power generation unit 35 and the power received from the built-in battery 108 to the detection unit 31, the analysis unit 32, and the wireless communication unit 33. The built-in battery 108 is configured as a rechargeable secondary battery, so that the power supply unit 34 may charge the built-in battery 108 with the power generated by the power generation unit 35. Further, when the power generated by the power generation unit 35 alone is not sufficient, the power supply unit 34 may supply the power received from the built-in battery 108 to each unit in the wireless slave device 30. The method of generating power of the power generation unit 35 is not limited. For example, the power generation unit 35 may be a power generation device that converts sunlight into electric energy (electric power). However, it is preferable that the power generation system uses energy such as sound or vibration originating from the inspection target object 50.

The automatic inspection system 1A according to the second embodiment also has the same operation and effect as the automatic inspection system 1 according to the first embodiment. Further, in the automatic inspection system 1A according to the second embodiment, since the wireless slave device 30 includes the power generation unit 35, the replacement frequency of the built-in battery 108 can be prolonged as compared with the built-in battery 108 of the wireless slave device 30 according to the first embodiment.

### Third Embodiment

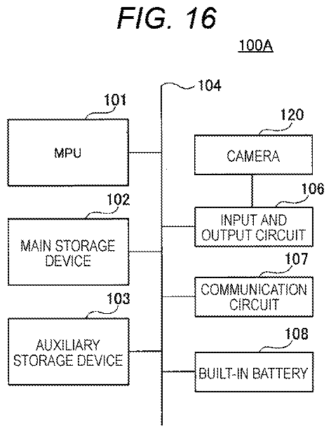

Next, an exemplary configuration and an exemplary operation of the automatic inspection system according to a third embodiment of the present disclosure will be described with reference to FIGS. 16 to 18.

It is assumed that, in the automatic inspection system according to the third embodiment, the detection unit 31 of the wireless slave device 30 is a camera, and accordingly, the image data obtained by capturing the inspection target object 50 by the detection unit 31 is used as the target of the learning process.

FIG. 16 is a block diagram showing an example of a hardware configuration of a computer 100A that configures the wireless slave device 30 used in the automatic inspection system according to the third embodiment.

The computer 100A is different from the computer 110 shown in FIG. 4 in that the part used as the detection unit 31, that is, the microphone 105 is replaced by the camera 120.

Although not shown, the camera 120 includes a lens, a CCD image sensor, an amplifier, an A/D converter, and the like. Accordingly, the detection unit 31 obtains, by the camera 120, image data including a visible image obtained by capturing the state of the inspection target object 50 in an imageable range with visible light. The image data is stored in the auxiliary storage device 103 through the input and output circuit 106, and is appropriately read from the auxiliary storage device 103 by software operating on the MPU 101.

Then, the analysis unit 32 transmits, to the analysis management device 10, image data including the visible image representing the state of the inspection target object 50 as learning data N. In addition, the analysis unit 32 obtains, as an analysis result, the degree of difference between the visible image obtained by the detection unit 31 and the visible image of the inspection target object 50 captured in a normal state, based on the learning result N received from the analysis management device 10. The analysis result is transmitted to the wireless master device 70 through the wireless relay device 60.

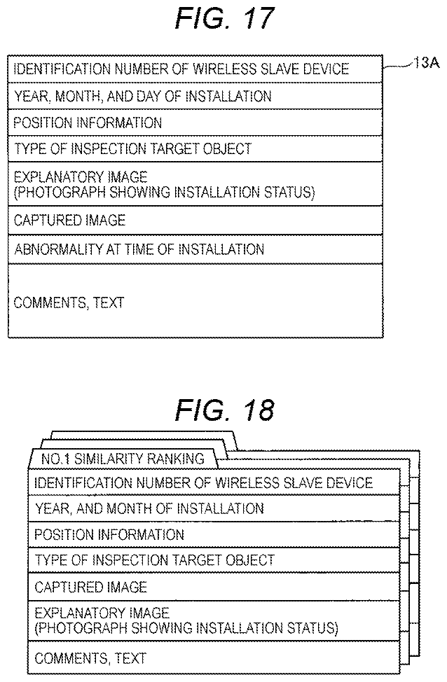

FIG. 17 is a diagram showing an exemplary configuration of the background information 13A registered in the registration database 19.

Unlike the background information 13 shown in FIG. 7, the background information 13A does not include an item related to the sound pressure of the sound generated by the inspection target object 50 which has been deleted. Instead, the background information 13A includes a captured image of the inspection target object 50 captured by the camera 120.

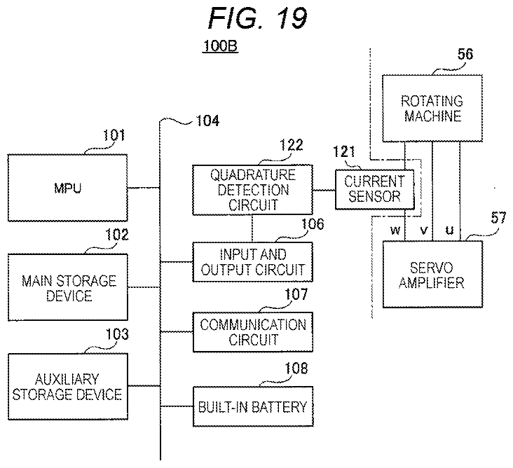

FIG. 18 is a diagram showing an example of a prediction notification indicated by the prediction notification unit 22.

In the present embodiment, instead of the item related to the sound pressure of the sound generated by the inspection target object 50, the captured image of the inspection target object 50 captured by the camera 120 is displayed. The installation worker 90 may select appropriate background information 13A as the learning result N to be set in the wireless slave device 30 while watching the predicted notified captured image, and issue an instruction to register the selected background information 13A as the background information N in the registration database 19.

In the automatic inspection system according to the third embodiment described above, the learning process is performed by the analysis management device 10 based on the image data of the captured image captured by the camera 120, and the learning result N is set in the wireless slave device 30. Accordingly, when there occurs even a slight change in the inspection target object 50, the wireless slave device 30 may transmit the degree of difference from the visible image captured in the normal state to the wireless master device 70 as an analysis result. Then, when the wireless master device 70 determines that an abnormality has occurred in the inspection target object 50, the operator may quickly respond to the abnormality that has occurred in the inspection target object 50.

### Fourth Embodiment

Next, an exemplary configuration and an exemplary operation of the automatic inspection system according to a fourth embodiment of the present disclosure will be described with reference to FIG. 19.

It is assumed that, in the automatic inspection system according to the fourth embodiment, the detection unit 31 of the wireless slave device 30 is a current detection unit, and accordingly, the detection unit 31 uses a change in current supplied to the inspection target object 50 as the target of the learning process.

FIG. 19 is a block diagram showing an example of a hardware configuration of a computer 100B that configures the wireless slave device 30 used in the automatic inspection system according to the fourth embodiment.

The computer 100B is different from the computer 100 shown in FIG. 4 in that the part used as the detection unit 31, that is, the microphone 105 is replaced by a current sensor 121 (CT: Current Transformer) and a quadrature detection circuit 122.

In the present embodiment, a three-phase AC motor installed on a production line is a rotating machine 56 as an example of the inspection target object 50, for example. The rotating machine 56 is connected to a servo amplifier 57 through three power lines (u-phase, v-phase, and w-phase, respectively), and is driven by a three-phase AC power supplied from the servo amplifier 57.

Here, the current sensor 121 is connected to at least one of the three power lines (in this example, for example, to a w-phase power line), and the current sensor 121 monitors the w-phase current. The current detection signal obtained by the current sensor 121 is supplied to the quadrature detection circuit 122. Then, the quadrature detection circuit 122 detects the current detected by the current sensor 121, measures the current flowing through the w-phase power line, and outputs current data. Accordingly, by the current sensor 121 and the quadrature detection circuit 122, the detection unit 31 obtains the current data including the current value of the current for driving the inspection target object 50. The current data is stored in the auxiliary storage device 103 through the input and output circuit 106, and is appropriately read from the auxiliary storage device 103 by software operating on the MPU 101.

Then, the analysis unit 32 transmits the current value indicating the state of the inspection target object 50 to the analysis management device 10 as the learning data N. In addition, the analysis unit 32 obtains, as an analysis result, the degree of difference between the current value obtained by the detection unit 31 and the current value of the current supplied to the inspection target object 50 in a normal state based on the learning result N received from the analysis management device 10. The analysis result is transmitted to the wireless master device 70.

In the automatic inspection system according to the fourth embodiment described above, the learning process is performed based on the current data obtained by measuring the current value of the current supplied to the rotating machine 56 by the quadrature detection circuit 122 with reference to the current detection signal obtained by the current sensor 121. Then, since the degree of difference from the current value of the current supplied in the normal state is transmitted as an analysis result to the wireless master device 70, the wireless slave device 30 can quickly determine the abnormality of the rotating machine 56 even when there occurs a slight change in the current supplied to the rotating machine 56.

### Modification Example

Note that the detection unit 31 according to each of the embodiments described above is replaced by a device that may obtain various other information. Hereinafter, the examples of the detection unit 31 measuring a temperature value, obtaining a thermal image, and obtaining a vibration value will be described in order.

### <Example of Measuring Temperature Value>

For example, a thermocouple capable of measuring the temperature generated from the inspection target object 50 may be provided for the detection unit 31. For the thermocouple, it is desirable to use a contact thermocouple capable of contacting a specific location of the inspection target object 50 and measuring the temperature of the specific location. In this case, the detection unit 31 is installed in contact with the inspection target object 50 and measures a temperature value of heat generated by the inspection target object 50.

The analysis unit 32 transmits the temperature value indicating the state of the inspection target object 50 to the analysis management device 10 as the learning data N. Then, the analysis unit 32 obtains, as an analysis result, the degree of difference between the temperature value obtained by the detection unit 31 and the temperature value of heat generated by the inspection target object 50 in a normal state based on the learning result N received from the analysis management device 10. Thereafter, the wireless slave device 30 transmits the analysis result to the wireless master device 70 through the wireless relay device 60. The wireless master device 70 may determine whether the inspection target object 50 is in a normal state or in an abnormal state, based on the analysis result collected from the wireless slave device 30.

### <Example of Obtaining Thermal Image>

Further, for the detection unit 31, a thermal image camera capable of detecting infrared rays emitted from the inspection target object 50 and capturing a thermal image of the inspection target object 50 may be provided. In this case, the detection unit 31 is installed separately from the inspection target object 50, and obtains a thermal image based on the temperature of the inspection target object 50.

The analysis unit 32 transmits the thermal image representing the state of the inspection target object 50 to the analysis management device 10 as learning data N. Then, the analysis unit 32 obtains, as an analysis result, the degree of difference between the thermal image obtained by the detection unit 31 and the thermal image of the inspection target object 50 obtained in a normal state, based on the learning result N received from the analysis management device 10. Thereafter, the wireless slave device 30 transmits the analysis result to the wireless master device 70 through the wireless relay device 60. The wireless master device 70 may determine whether the inspection target object 50 is in a normal state or in an abnormal state, based on the analysis result collected from the wireless slave device 30.

### <Example of Obtaining Vibration Value>

Further, a vibration sensor capable of detecting the vibration generated by the inspection target object 50 may be provided for the detection unit 31. In this case, the detection unit 31 is installed in contact with the inspection target object 50 and obtains a vibration value of the vibration generated by the inspection target object 50.

The analysis unit 32 transmits the vibration value representing the state of the inspection target object 50 to the analysis management device 10 as learning data N. Then, the analysis unit 32 obtains, as an analysis result, the degree of difference between the vibration value obtained by the detection unit 31 and the vibration value of the inspection target object 50 obtained in a normal state, based on the learning result N received from the analysis management device 10. Thereafter, the wireless slave device 30 transmits the analysis result to the wireless master device 70 through the wireless relay device 60. The wireless master device 70 may determine whether the inspection target object 50 is in a normal state or in an abnormal state, based on the analysis result collected from the wireless slave device 30.

It should be noted that the present disclosure is not limited to the embodiments described above, and it is needless to say that various other applications and modifications may be implemented without departing from the gist of the present disclosure described in the claims. Each component according to the present disclosure may be arbitrarily selected, and the inventions having the selected configurations are also included in the present disclosure. Furthermore, the configurations described in the claims may be combined in combinations other than the combinations explicitly stated in the claims, and the configurations and process methods of the embodiments may be appropriately changed within the scope of achieving the object of the present disclosure.

Further, the control lines and the information lines in the drawing show those considered to be necessary for the explanation, and it is not necessarily limited that all the control lines and information lines are shown on the product. In practice, it may be considered that almost all components are connected to each other.

1. An automatic inspection system comprising:
a wireless slave device; a setting device capable of communicating with the wireless slave device; and an analysis management device capable of communicating with the setting device,
wherein the wireless slave device includes
a detection unit that detects a state of an inspection target object,
an analysis unit that transmits the detected state of the inspection target object to the setting device as learning data, causes the setting device to set a learning result regarding the state of the inspection target object, and obtains, as an analysis result, a degree of difference between the state of the inspection target object detected by the detection unit and the normal state of the inspection target object based on the set learning result,
a wireless communication unit that wirelessly transmits data including the analysis result to a wireless master device that collects the analysis result, and
a power supply unit that supplies power to the detection unit, the analysis unit, and the wireless communication unit,
the setting device includes
a learning data transfer unit that transfers the learning data received from the wireless slave device to the analysis management device, and
a learning result setting unit that sets the learning result transmitted from the analysis management device in the analysis unit of the wireless slave device, and
the analysis management device includes
a characteristic value extraction unit that extracts a characteristic value characterizing the state of the inspection target object from the learning data transferred from the setting device, and transmits the extracted characteristic value to the setting device as a learning result.

2. The automatic inspection system according to claim 1, wherein the analysis management device includes a similarity selection unit that transmits, to the setting device, background information that is similar to the characteristic value, is associated with a registered characteristic value registered in the analysis management device, and indicates a status of the wireless slave device installed on the inspection target object, and
the setting device includes
a prediction notification unit that notifies the background information related to the inspection target object which is predicted by the analysis management device to be similar to the state of the inspection target object, and
a background information registration unit that registers edited background information in the analysis management device, when the background information notified by the prediction notification unit is edited.

3. The automatic inspection system according to claim 2, wherein the prediction notification unit notifies the registered characteristic value including at least the background information in a descending order of similarity to the characteristic value.

4. The automatic inspection system according to claim 3, wherein the analysis management device includes a registration database for registering, as management information, the learning data transferred from the setting device, the learning result set in the wireless slave device, and the background information of the wireless slave device in association with each other.

5. The automatic inspection system according to claim 4, wherein the registered characteristic value includes typical data representing a typical characteristic of the inspection target object, and
the characteristic value extraction unit matches the typical data with the learning data, and sets a new characteristic value extracted from the learning data as the learning result.

6. The automatic inspection system according to claim 5, wherein the detection unit obtains a sound generated by the inspection target object, and
the analysis unit transmits, as the learning data, the sound indicating the state of the inspection target object to the analysis management device, and obtains, as the analysis result, a degree of difference between the sound obtained by the detection unit and a sound generated by the inspection target object in a normal state based on the learning result set from the analysis management device.

7. The automatic inspection system according to claim 5, wherein the detection unit obtains a visible image of the inspection target object captured with visible light, and
the analysis unit transmits, as the learning data, the visible image representing the state of the inspection target object to the analysis management device, and obtains, as the analysis result, a degree of difference between the visible image obtained by the detection unit and a visible image of the inspection target object captured in a normal state, based on the learning result received from the analysis management device.

8. The automatic inspection system according to claim 5, wherein the detection unit obtains a current value of a current driving the inspection target object, and
the analysis unit transmits, as the learning data, the current value representing the state of the inspection target object to the analysis management device, and obtains, as the analysis result, a degree of difference between the current value obtained by the detection unit and a current value of the current supplied to the inspection target object in a normal state, based on the learning result received from the analysis management device.

9. The automatic inspection system according to claim 5, wherein the detection unit detects a temperature value of heat generated by the inspection target object, and
the analysis unit transmits, as the learning data, the temperature value representing the state of the inspection target object to the analysis management device, and obtains, as the analysis result, a degree of difference between the temperature value obtained by the detection unit and a temperature value of heat generated by the inspection target object in a normal state, based on the learning result received from the analysis management device.

10. The automatic inspection system according to claim 5, wherein the detection unit obtains a thermal image based on a temperature of the inspection target object, and
the analysis unit transmits, as the learning data, the thermal image representing the state of the inspection target object to the analysis management device, and obtains, as the analysis result, a degree of difference between the thermal image obtained by the detection unit and a thermal image of the inspection target object captured in a normal state, based on the learning result received from the analysis management device.

11. The automatic inspection system according to claim 5, wherein the detection unit detects a vibration value of vibration generated by the inspection target object, and
the analysis unit transmits, as the learning data, the vibration value representing the state of the inspection target object to the analysis management device, and obtains, as the analysis result, a degree of difference between the vibration value obtained by the detection unit and a vibration value of the inspection target object obtained in a normal state, based on the learning result received from the analysis management device.

12. The automatic inspection system according to claim 1, wherein the wireless master device receives from the wireless slave device and manages data including the analysis result, and publishes a determination result of the inspection target object determined from the analysis result extracted from the data based on a request from a monitoring terminal that monitors the state of the inspection target object to the monitoring terminal.

13. The automatic inspection system according to claim 12, further comprising:
the wireless master device that instructs, for a plurality of the wireless slave devices, a transmission order of the data including the analysis result; and
a wireless relay device that is arranged between the wireless master device and the wireless slave devices and wirelessly transmits, to the wireless master device, the data received from the wireless slave devices according to the transmission order.

14. A wireless slave device comprising:
a detection unit that detects a state of an inspection target object;
an analysis unit that transmits the detected state of the inspection target object to a setting device as learning data, and obtains, as an analysis result, a degree of difference between the state of the inspection target object detected by the detection unit and a normal state of the inspection target object based on a learning result regarding the state of the inspection target object set by the setting device;
a wireless communication unit that wirelessly transmits data including the analysis result to a wireless master device that collects the analysis result; and
a power supply unit that supplies power to the detection unit, the analysis unit, and the wireless communication unit.
